(19) United States
(12) Patent Application Publication
(10) Pub. No.: US 2025/0384223 A1
(43) Pub. Date: Dec. 18, 2025

(54) Machine Learning Systems and Methods for Many-Hop Fact Extraction and Claim Verification

(71) Applicant: Insurance Services Office, Inc., Jersey City, NJ (US)

(72) Inventors: Yichen Jiang, Seattle, WA (US); Shikha Bordia, Secaucus, NJ (US); Zheng Zhong, Seattle, WA (US); Charles Dognin, Rockville Centre, NY (US); Maneesh Kumar Singh, Princeton, NJ (US); Mohit Bansal, Carrboro, NC (US)

(73) Assignee: Insurance Services Office, Inc., Jersey City, NJ (US)

(21) Appl. No.: 19/316,489

(22) Filed: Sep. 2, 2025

Related U.S. Application Data
(62) Division of application No. 17/534,899, filed on Nov. 24, 2021, now Pat. No. 12,406,150.
(60) Provisional application No. 63/118,074, filed on Nov. 25, 2020.

(51) Int. Cl. G06F 40/40; G06F 16/35; G06F 40/226; G06F 40/295; G06N 5/04

(52) U.S. Cl. CPC G06F 40/40; G06F 40/226; G06F 40/295; G06N 5/04; G06F 16/35

(57) ABSTRACT

Machine learning (ML) systems and methods for fact extraction and claim verification are provided. The system receives a claim and retrieves a document from a dataset. The document has a first relatedness score higher than a first threshold, which indicates that ML models of the system determine that the document is most likely to be relevant to the claim. The dataset includes supporting documents and claims including a first group of claims supported by facts from more than two supporting documents and a second group of claims not supported by the supporting documents. The system selects a set of sentences from the document. The set of sentences have second relatedness scores higher than a second threshold, which indicate that the ML models determine that the set of sentences are most likely to be relevant to the claim. The system determines whether the claim includes facts from the set of sentences.

### RELATED APPLICATIONS

This application is a divisional application of U.S. patent application Ser. No. 17/534,899 filed on Nov. 24, 2021, which claims priority to U.S. Provisional Patent Application Ser. No. 63/118,074 filed on Nov. 25, 2020, the entire disclosures of which are hereby expressly incorporated by reference.

### BACKGROUND

### Technical Field

The present disclosure relates generally to the field of machine learning. More specifically, the present disclosure relates to machine learning systems and methods for many-hop fact extraction and claim verification.

### Related Art

The proliferation of social media platforms and digital content has been accompanied by a rise in deliberate disinformation and hoaxes, leading to polarized opinions among masses. With the increasing number of inexact statements, there is significant interest in fact-checking systems that can verify claims based on automatically-retrieved facts and evidence. Some examples of fact extraction and claim verification provide an open-domain fact extraction and verification dataset closely related to this real-world application. However, more than 87% of the claims in these examples require information from a single Wikipedia article. Additionally, real-world claims might refer to information from multiple sources. Some question-and-answer (QA) datasets represent the first efforts to challenge models to reason with information from multiple sources. However, such datasets cannot distinguish multi-hop models from single-hop models and are not effective for the multi-hop models.

Moreover, some example models are shown to degrade in adversarial evaluation, where word-matching reasoning shortcuts are suppressed by extra adversarial documents. Some example open-domain settings are limited to two supporting documents that are retrieved by a neural model exploiting a single hyperlink. Hence, while providing very useful starting points for the community, some open-domain fact extraction and verification datasets are mostly restricted to a single-hop setting and some example multi-hop QA datasets are limited by the number of reasoning steps and the word overlapping between a question and all the evidences.

Accordingly, what would be desirable are machine learning systems and methods for many-hop fact extraction and claim verification, which address the foregoing, and other, needs.

### SUMMARY

The present disclosure relates to machine learning systems and methods for many-hop fact extraction and claim verification. The system receives a claim comprising one or more sentences. The system retrieves, based at least in part on one or more machine learning models, a document from a dataset. The document has a first relatedness score higher than a first threshold. The first relatedness score indicates that the one or more machine learning models determines that the document is most likely to be relevant to the claim. The dataset comprises a plurality of supporting documents and a plurality of claims. The plurality of claims include a first group of claims supported by facts from more than two supporting documents from the plurality of supporting documents and a second group of claims not supported by the plurality of supporting documents. The system selects, based at least in part on the one or more machine learning models, a set of sentences from the document. The set of sentences has second relatedness scores higher than a second threshold. The second relatedness scores indicate that the one or more machine learning models determine that the set of sentences are most likely to be relevant to the claim. The system determines, based at least in part on the one or more machine learning models, whether the claim includes one or more facts from the set of sentences.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating an embodiment of the system of the present disclosure;

FIG. 2 is a flowchart illustrating overall processing steps carried out by the system of the present disclosure;

FIG. 3 is a flowchart illustrating data collection steps for the “HoVer” dataset of the present disclosure;

FIG. 4 is a table showing types of many-hop reasoning graphs for extracting evidence and verifying claims in a dataset, in accordance with the present disclosure;

FIG. 5 illustrates an example automatic word substitution for claim mutation of the present disclosure;

FIG. 6 illustrates ambiguities in paragraphs of information capable of being detected by the systems of the present disclosure;

FIG. 7 illustrates original claims, mutated claims, supporting documents, and labels created by the system of the present disclosure;

FIG. 8 illustrates a screenshot of a user interface generated by the system of the present disclosure for gathering data to be processed by many-hop machine learning;

FIG. 9 illustrates a screenshot of a user interface generated by the system of the present disclosure to create more specific claims;

FIG. 10 illustrates a screenshot of a user interface generated by the system of the present disclosure for labeling claims;

FIG. 11 is a table showing the sizes of supported and non-supported classes and associated hops for creating machine learning models of the system of the present disclosure;

FIG. 12 is a diagram illustrating a baseline machine learning system with a 4-stage architecture in accordance with the present disclosure;

FIG. 13 illustrates performance of TF-IDF document retrieval and EM/F1 scores of neural based document retrieval models evaluated on supported claims by the system of the present disclosure;

FIG. 14 illustrates EM/F1 scores of sentence retrieval models evaluated on supported claims by the system of the present disclosure;

FIG. 15 illustrates claim verification accuracy of natural language inference (NLI) models evaluated on supported claims in a development set of the system of the present disclosure;

FIG. 16 illustrates claim verification accuracy and HoVer scores of an entire pipeline evaluated on supported claims by the system of the present disclosure;

FIG. 17 illustrates evidence F1 and HoVer scores of the best model from FIG. 16, evaluated on a test set of the system of the present disclosure; and

FIG. 18 is a diagram illustrating hardware and software components capable of being utilized to implement the system of the present disclosure.

### DETAILED DESCRIPTION

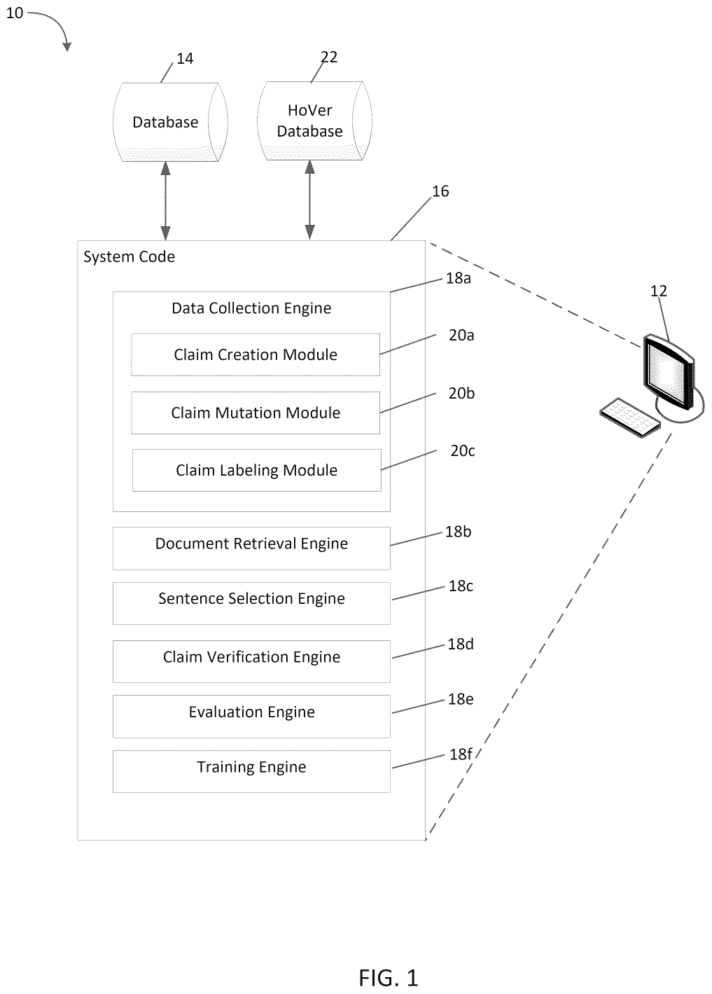

The present disclosure relates to machine learning systems and methods for many-hop fact extraction and claim verification, as described in detail below in connection with FIGS. 1-18.

The machine learning systems and methods disclosed herein include a dataset for many-hop fact extraction and claim verification (also referred to as Hoppy Verification (HoVer)). The HoVer dataset is a custom-generated machine learning dataset that challenges machine learning systems/models to extract facts from several textual sources (e.g., Wikipedia articles) that are relevant to a claim and to classify whether the claim is supported or not supported by facts. A claim includes one or more sentences that have information about single or multiple entities, such as a statement or an assertion about the single or multiple entities without providing evidence, facts or proof. An entity can be a thing, a person, a product, an organization, an object, a concept or the like. In the HoVer dataset, the claims need evidence to be extracted from multiple textual sources (e.g., multiple documents) and the claims embody reasoning graphs of diverse shapes. The HoVer dataset includes 3-hop claims and 4-hop claims that include multiple sentences, which adds to complexity of understanding long-range dependency relations such as coreference. A coreference occurs when two or more expressions in a text refer to the same person or thing. For a particular claim, the HoVer dataset increases the number of reasoning hops and/or the number of supporting documents that provide evidence and facts to a corresponding claim, which results in significant degradation on some semantic-matching models (e.g., an existing state-of-the-art models), hence demonstrating the necessity of many-hop reasoning to facilitate the development of machine learning systems/models (e.g., semantic-matching models, natural language processing models, or the like). In some embodiments, claims of the HoVer dataset need evidence from as many as four English Wikipedia articles and contain significantly less semantic overlap between the claims and some supporting documents to avoid reasoning shortcuts. In some embodiments, the HoVer dataset includes 26k claims. Importantly, the machine learning datasets (e.g., the HoVer dataset) generated by the systems and methods disclosed herein significantly improve the accuracy of machine learning systems and models.

Turning to the drawings, FIG. 1 is a diagram illustrating an embodiment of the system 10 of the present disclosure. The system 10 can be embodied as a central processing unit 12 (processor) in communication with a database 14 and a HoVer database 22. The processor 12 can include, but is not limited to, a computer system, a server, a personal computer, a cloud computing device, a smart phone, or any other suitable device programmed to carry out the processes disclosed herein. The system 10 can retrieve data from the database 14 associated with one or more machine learning models, and from the HoVer database 22.

The database 14 can include various types of data including, but not limited to, one or more machine learning models, and one or more outputs from various components of the system 10 (e.g., outputs from a data collection engine 18a, a claim creation module 20a, a claim mutation module 20b, a claim labeling module 20c, a document retrieval engine 18b, a sentence selectin module 18c, a claim verification engine 18d, an evaluation engine 18e, and a training engine 18f). Examples of a machine learning model can include a natural language processing model, a natural language inference model, a language representation model, a pre-trained machine learning model (e.g., a pre-trained natural language processing model, a pre-trained natural language inference model, a pre-trained language representation model, or the like), a neural-based document retrieval model, a neural-based sentence selectin model, a neural network model, or any suitable machine learning model for fact extraction and claim verification.

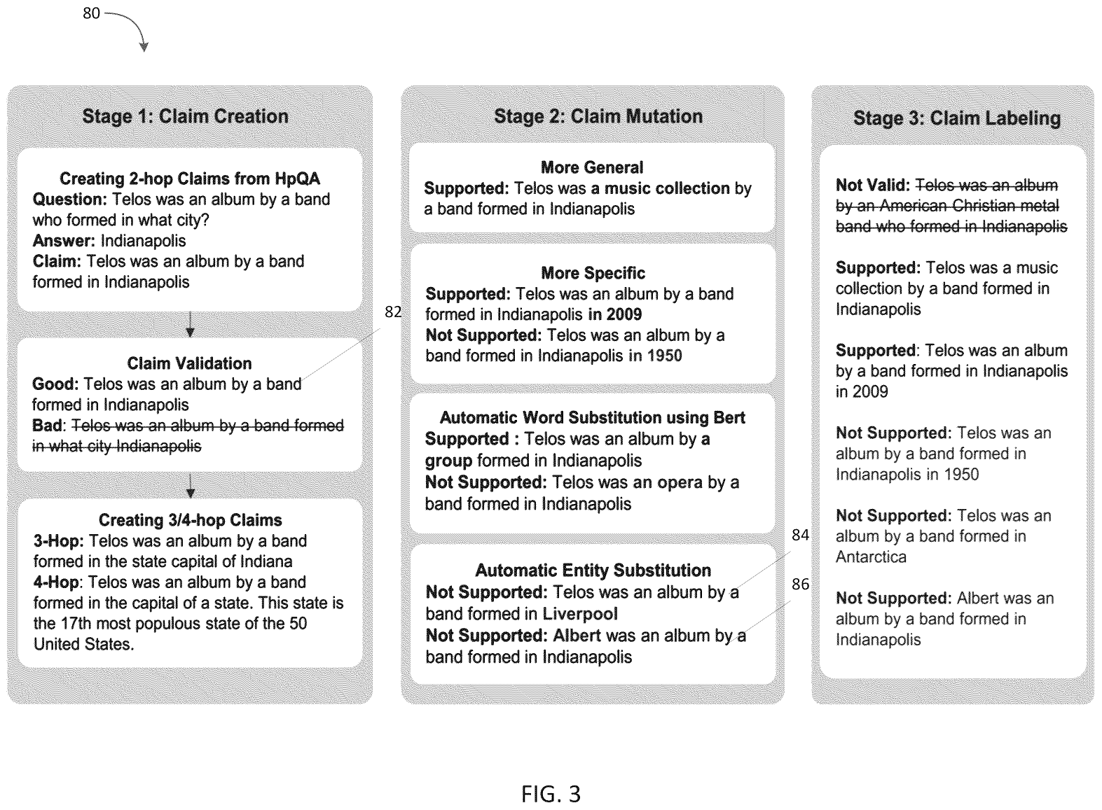

The HoVer database 22 includes a HoVer dataset having multiple supporting documents and multiple claims. The multiple claims include a first group of claims and a second group of claims. The first group of claims include claims supported by facts from more than two supporting documents. A supporting document can provide one or more facts to support a claim of the first group of claims. The second group of claims includes claims that are not supported by any of the supporting documents. Examples of the HoVer dataset are further described in FIGS. 3-7.

The system 10 includes system code 16 (non-transitory, computer-readable instructions) stored on a computer-readable medium and executable by the hardware processor 12 or one or more computer systems. The system code 16 can include various custom-written software modules that carry out the steps/processes discussed herein, and can include, but is not limited to, the data collection engine 18a, the claim creation module 20a, the claim mutation module 20b, the claim labeling module 20c, the document retrieval engine 18b, the sentence selectin module 18c, the claim verification engine 18d, the evaluation engine 18e, and the training engine 18f. The system code 16 can be programmed using any suitable programming languages including, but not limited to, C, C++, C#, Java, Python, or any other suitable language. Additionally, the system code 16 can be distributed across multiple computer systems in communication with each other over a communications network, and/or stored and executed on a cloud computing platform and remotely accessed by a computer system in communication with the cloud platform. The system code 16 can communicate with the database 14, which can be stored on the same computer system as the code 16, or on one or more other computer systems in communication with the code 16.

Still further, the system 10 can be embodied as a customized hardware component such as a field-programmable gate array (“FPGA”), an application-specific integrated circuit (“ASIC”), embedded system, or other customized hardware components without departing from the spirit or scope of the present disclosure. It should be understood that FIG. 1 is only one potential configuration, and the system 10 of the present disclosure can be implemented using a number of different configurations.

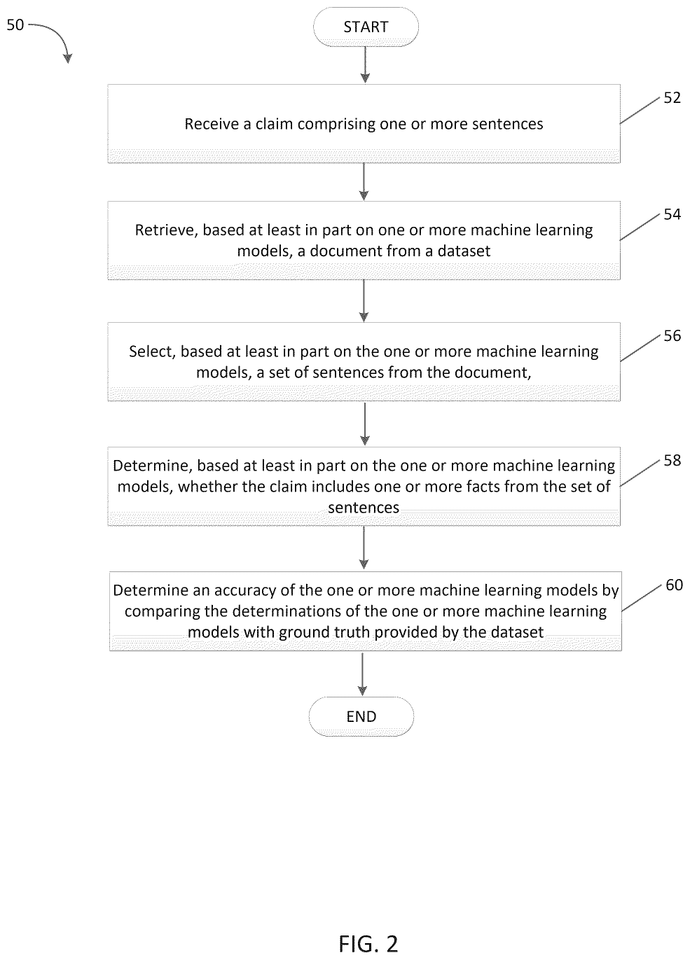

FIG. 2 is a flowchart illustrating overall processing steps 50 carried out by the system 10 of the present disclosure. Beginning in step 52, the system 10 receives a claim having one or more sentences. For example, the system 10 can receive a claim from a user input or from a third-party system (e.g., a computing device, a computing server, or the like). It should be understood that the system 10 can perform the aforementioned task via the document retrieval engine 18b.

In step 54, the system 10 retrieves, based at least in part on one or more machine learning models, a document from a dataset. For example, the system 10 can use a pre-trained language representation model (e.g., bidirectional-encoder-representations-from-transformers (BERT)-base models) that takes a single document p∈Pᵣ and the claim c as the input, and outputs a score that reflects the relatedness between p and c. The document p can have a relatedness score higher than a first threshold indicating that the one or more machine learning models determine that the document is most likely to be relevant to the claim. For example, the system 10 can rank the documents having relatedness scores higher that a threshold of κₚ, and selects a set Pᵣ (e.g., multiple documents of top-ranking kₚ documents). The system 10 can further select the document p from the set Pᵣ. For example, the document p can have highest relatedness score. It should be understood that the system 10 can perform the aforementioned task via the document retrieval engine 18b.

In some embodiments, the system 10 can retrieve multiple documents in response to a query associated with claim prior to the step 54. For example, the system 10 can use a term frequency-inverse document frequency (TF-IDF) model that returns the k closest documents for a query using cosine similarity between binned uni-gram and bi-gram TF-IDF vectors. This step outputs a set Pᵣ of kᵣ document that are processed by downstream neural models, e.g., the above BERT-base model. It should be understood that the system 10 can perform the aforementioned task via the document retrieval engine 18b.

In some embodiments, the database can be the HoVer database 22 including the first group of claims and the second group of claims. In some embodiments, the first group of claims and the second group of claims of the HoVer dataset can be created by three main stages as shown in FIG. 3 (which illustrates data collection flow chart for HoVer dataset of the present disclosure).

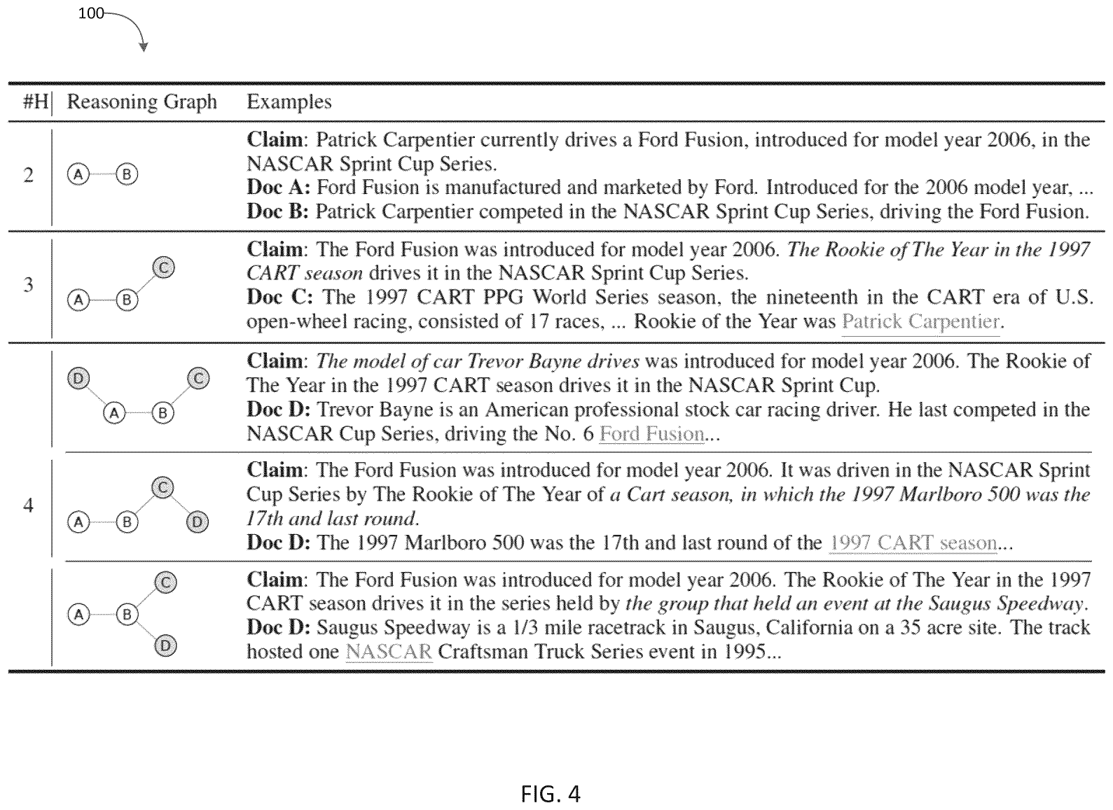

The first stage is referred as to claim creation that creates original claims based on question and answer pairs from one or more QA databases (e.g., HOTPOTQA database) and extends the original claims to claims supported by facts from more documents compared with the original claims. The QA database can be a remote database communicating with the system 10 via a communication network, or it can be included in the database 14. A (n-1)-hop claim can be created based on the QA questions, where n is an integer number equal to or greater than 2. For example, as shown in FIG. 3, a 2-hop claim is created from two supporting documents e.g., a question and an answer. The (n-1)-hop claim can be validated by trained users of the system to ensure the quality of the claims. For example, as shown in FIG. 3, the 2-hop claim is validated as a good claim. As another example, as shown in FIG. 4 (which illustrates a table 100 showing types of many-hop reasoning graphs to extract the evidence and to verify the claim in a dataset of the present disclosure), a valid 2-hop claim can be represented by a reasoning graph having two supporting documents A and B.

The system 10 can extend the valid (n-1)-hop claims to n-hop claims by substituting one or more entities of the valid (n-1)-hop claim with information from an additional supporting document. The information describes the one or more entities. For example, using a valid 2-hop claim c as an example, the valid 2-hop claim c includes facts from two supporting documents A={a₁, a₂}. c is extended to a new, 3-hop claim ê by substituting a named entity e in c with information from another English Wikipedia article a₃ that describes e. The resulting 3-hop claim ê hence has three supporting document {a₁, a₂, a₃}. This process can be repeated to extend the 3-hop claims to include facts from the forth document.

In some embodiments, the system 10 can extend the valid (n-1)-hop claims to n-hop claims by substituting one or more entities of the valid (n-1)-hop claim with information from an additional supporting document. The additional supporting document can include a hyperlink of the one or more entities in a text body of the additional supporting document, and a title of the additional supporting document is mentioned in a text body of a supporting document of the valid (n-1)-hop claim. For example, two example methods to substitute different entities e, leading to 4-hop claims with various reasoning graphs are described below.

In an example Method 1, the entity e can be the title of a document aₖ∈E A that supports the 2-hop claim. The additional supporting document â€A can have a text body mentioning e's hyperlink. The system 10 can exclude â whose title is mentioned in the text body of one of the document in A. a₃ can be selected from a candidate group of â. The 3-hop claim ê is created by replacing e in c with a relative clause or phrase using information from a sentence s∈a₃. For example, as shown in FIG. 4, “Patrick Carpentier” is an entity in a 2-hop claim (e.g., the first row of the table 100). Document C is an additional supporting document having a text body mentioning the entity's hyperlink. A 3-hop claim (e.g., the second row of the table 100) is created by replacing “Patrick Carpentier” in the 2-hop claim with a relative clause or phrase (e.g., “The Rookie of The Year in the 1997CART season”) using information from the document C. “Patrick Carpentier” is supported by the document B. Accordingly, in the reasoning graph for the 3-hop claim, a node representing the document C is connected to a node representing the document B.

In an example Method 2, the entity e can be any other entity in the 2-hop claim. For example, the entity e is not the title of the document aₖ∈A but exists as a hyperlink in the text body of one document in A. For example, as shown in FIG. 4, the last 4-hop claim (e.g., the fifth row of table 100) is created via this method and the entity e is “NASCAR.” More particularly, the last 4-hop claim is created by replacing “NASCAR” in the 3-hop claim with a relative clause or phrase (e.g., “the group that held an event at the Saugus Speedway”) using information from the document D having a text body mentions e's hyperlink. “NASCAR” is supported by the document B. Accordingly, in the reasoning graph for the last 4-hop claim, a node representing the document D is further connected to a node representing the document B in addition to a node representing the document C connected to the node representing the document B.

In some embodiments, the example Method 1 can be used to extend the collected 2-hop claims, for which at least one â. Then both example methods can used to extend the 3-hop claims to 4-hop claims of various reasoning graphs. In a 3-document reasoning graph (e.g., the graph on the second row of the table 100 in FIG. 4), the title of the middle document (e.g., the document B represented by the node B of the table 100 in FIG. 4) is substituted out during the extension from the 2-hop claim and thus does not exist in the 3-hop claim. Therefore, the example Method 1, which replaces the title of one of the three documents for supporting the claim, can only be applied to either the leftmost or the rightmost document. In order to append the fourth document to the middle document in the 3-hop reasoning graph, a non-title entity in the 3-hop claim can be substituted, which can be achieved by the example Method 2. As shown in FIG. 4, the last 4-hop claim with a star-shape reasoning graph is the result of applying Method 1 for 3-hop extension and Method 2 for the 4-hop extension, while the first two 4-hop claims on the third and fourth rows of the table 100 are created by applying the Method 1 twice. It should be understood that the system 10 can perform the aforementioned tasks via the claim creation module 20a of the data collection engine 18a.

The second stage is referred to as claim mutation, and collects new claims that are not necessarily supported by the facts. Four types of example mutation methods (e.g., shown in the middle column of FIG. 3) as described below.

In some embodiments, the system 10 can make a claim more specific or general compared with a corresponding original claim of the first group of claims. A more specific claim contains information that is not in a corresponding original claim of the first group of claims. A more general claim contains less information than a corresponding original claim. For example, titles of the supporting documents for supporting a claim can be replaced and the same set of evidence as the original claims can be used for verifications. Examples of a more general claim and a more specific claim can be found in in the middle column of FIG. 3. As another example, an original claim states that Skagen Painter Peder Severin Kroyer favored naturalism along with Theodor Esbern Philipsen and the artist Ossian Elgstrom studied with in 1907. A more specific claim states that Skagen Painter Peder Severin Kroyer favored naturalism along with Theodor Esbern Philipsen and the muralist Ossian Elgstrom studied with in 1907. A more general claim states that Skagen Painter Peder Severin Krøyer favored naturalism along with Theodor Esbern Philipsen and the artist Ossian Elgstrom studied with in the early 1900s.

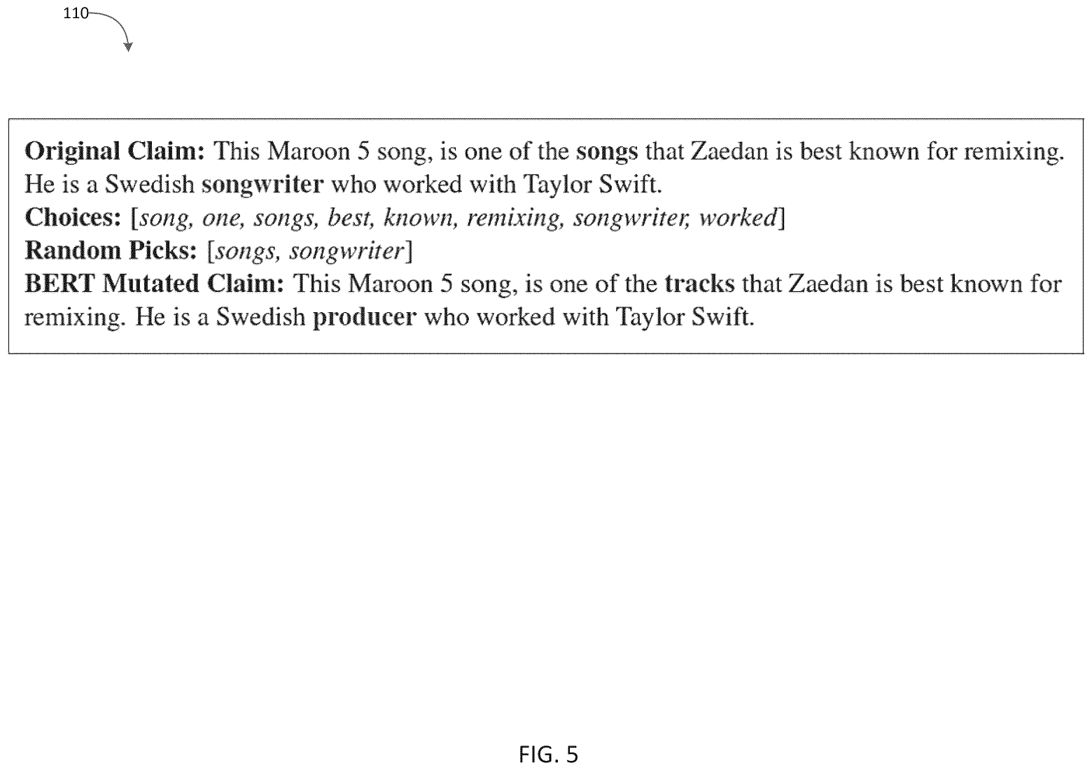

In some embodiments, the system 10 can perform an automatic word substitution. In this mutation process, a word is sampled from a claim that is neither a named entity nor a stopword. A pre-trained machine learning model (e.g., a BERT-large model) can be used to predict a masked token. The system 10 can keep the claims where (1) the new word predicted by BERT and the masked word do not have a common lemma and where (2) the cosine similarity of the BERT encoding between the masked word and the predicted word lie between 0.7 and 0.8. For example, FIG. 5 illustrates an example automatic word substitution 110 for claim mutation of the present disclosure. As shown in FIG. 5, several words (e.g., words included in “Choices”) can be sampled from an original claim. “song” and “songwriter” can be randomly selected. The pre-trained machine learning can predict new words (e.g., “tracks” and “producers”) that are used to replace the random picks to create a mutated claim.

In some embodiments, the system 10 performs an automatic entity substitution via machine learning models (e.g. pre-trained machine learning models). For example, the system 10 can substitute named entities in the claims. The system 10 an preform a named entity recognition on the claims. The system 10 can then randomly select a named entity that is not the title of any supporting document, and replace the named entity with an entity of the same type sampled from distracting documents selected by other models (e.g., TF-IDF models). For example, as shown in FIG. 3, mutated claims 84 and 86 are created by replacing an named entity “Indianapolis” with an entity “Liverpool,” and replacing an named entity “Telos” with an entity “Albert,” respectively. The mutated claims 84 and 86 can be automatically labeled as not supported claims.

In some embodiments, the system 10 can perform a claim negation. The system 10 can negate the original claims by removing or adding negation words (e.g., not), or substituting a phrase with its antonyms. For example, an original claim states that the scientific name of the true creature featured in “Creature from the Black Lagoon” is Eucritta melanolimnetes. A corresponding negated claim states that the scientific name of the imaginary creature featured in “Creature from the Black Lagoon” is Eucritta melanolimnetes. It should be understood that the system 10 can perform the aforementioned tasks via the claim mutation module 20b of the data collection engine 18a.

The third stage is also referred to as claim labeling, and identifies the claims to be either “SUPPORTED,” “REFUTED,” or “NOTENOUGHINFO” given the supporting facts. The label “SUPPORTED” indicates the claim is true based on the facts from the supporting documents and/or linguistic knowledge of users of the system (e.g., crowd-workers). The label “REFUTED” indicates that it is impossible for the claim to be true based on the supporting documents, and that information can be found to contradict the supporting documents. The label “NOTENOUGHINFO” indicates that a claim that does not fall into one of the two categories above, which suggests additional information is needed to validate whether the claim is true or false after reviewing the paragraphs. If it is possible for a claim to be true based on the information from paragraphs, the label “NOTENOUGHINFO” can be selected.

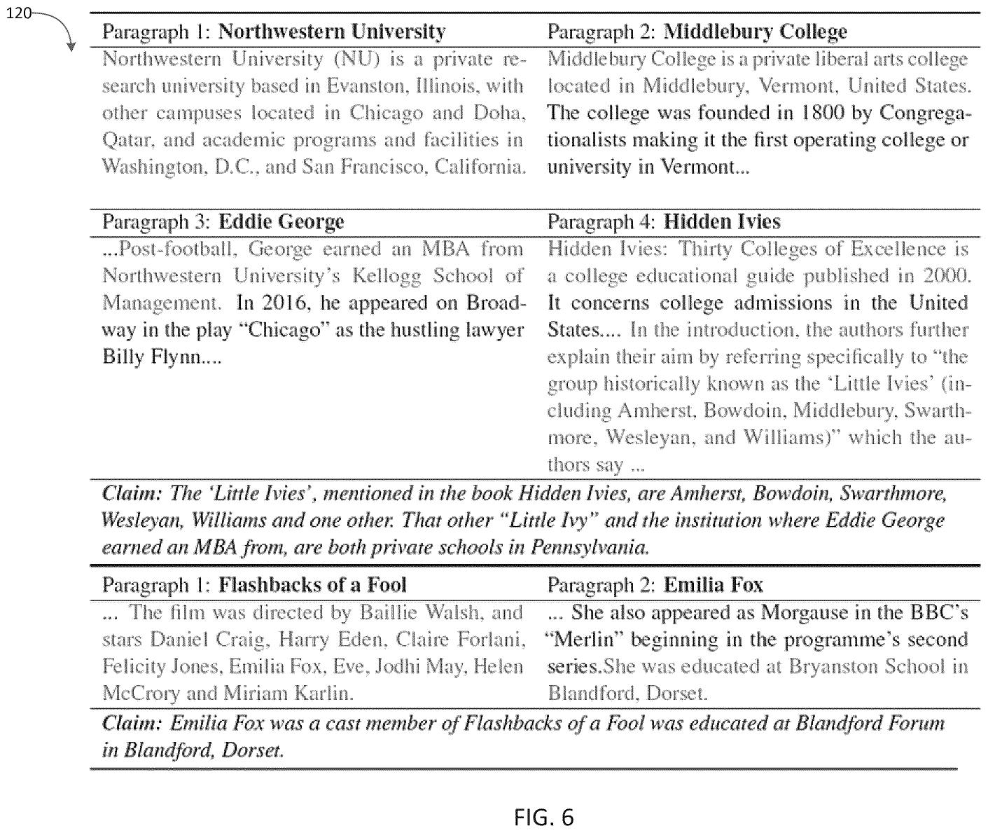

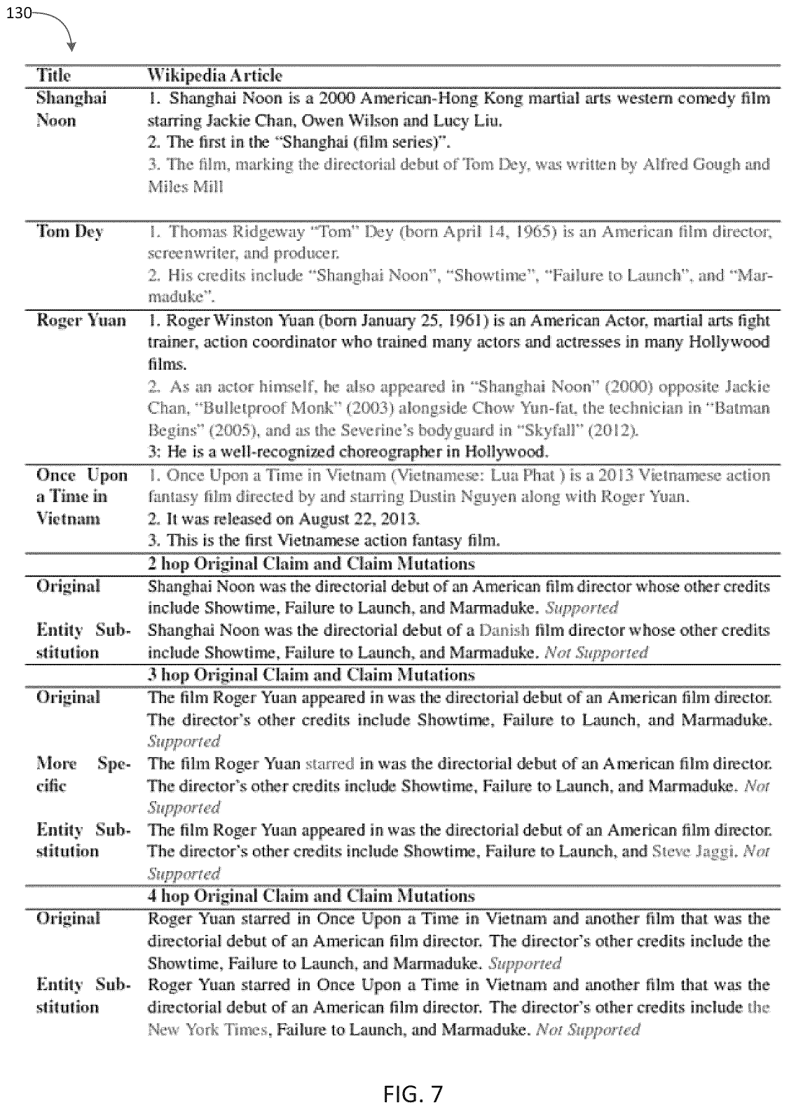

In some embodiments, the demarcation between “NOTENOUGHINFO” or “REFUTED” is subjective and the threshold could vary. For example, FIG. 6 illustrates a table 120 including two examples showing ambiguity between “REFUTED” and “NOTENOUGHINFO” labels. In the first example, external geographical knowledge about Vermont, Illinois and Pennsylvania is needed to refute the claim. In the second example, the claim cannot be directly refuted as Emilia Fox could have also been educated at Bryanston school and Blandford Forum. In some embodiments, a label “NOT SUPPORTED” can combine the “REFUTED” and “NOTENOUGHINFO” labels into a single class. For example, as shown FIG. 3, the claims can be manually labeled (e.g., by the crowd worker) or can be automatically labeled (e.g. by classification models). As another example, FIG. 7 illustrates a table 130 showing example original claims, mutated claims with their supporting documents and labels created by the system 10 of the present disclosure. It should be understood that the system 10 can perform the aforementioned tasks via the claim labeling module 20c of the data collection engine 18a.

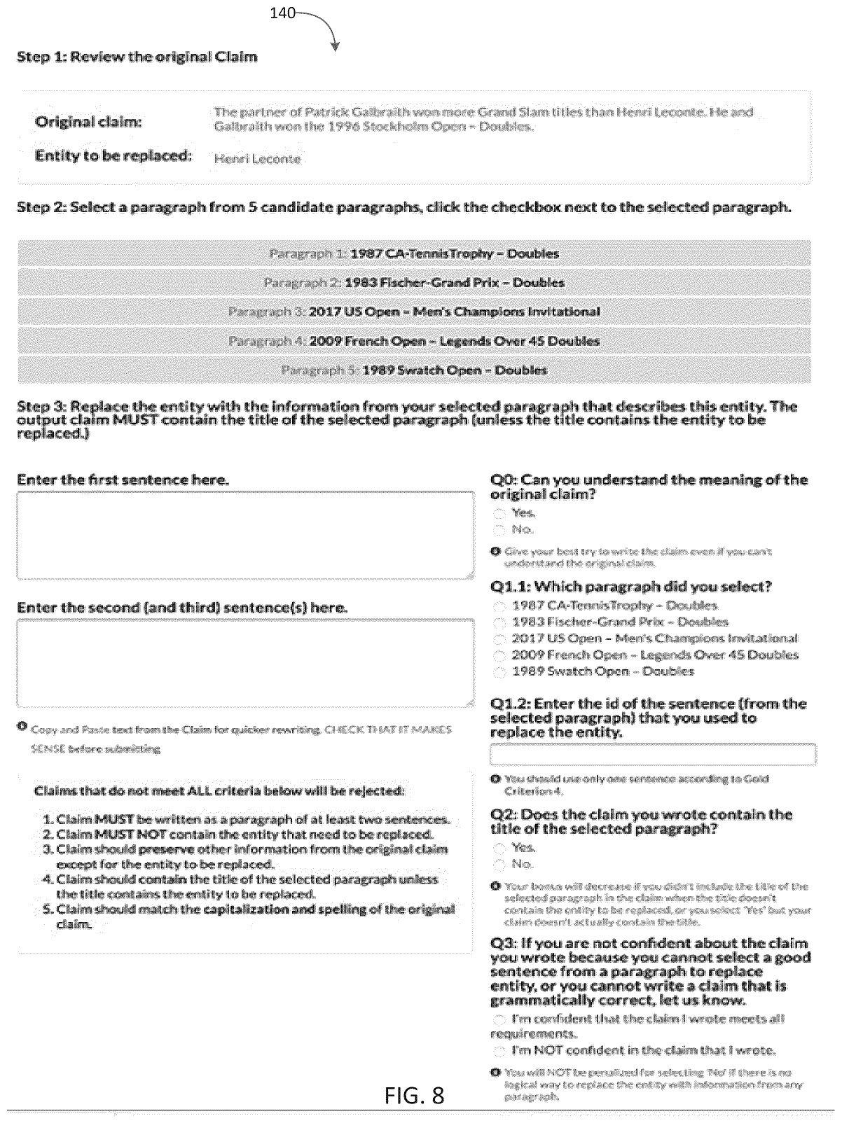

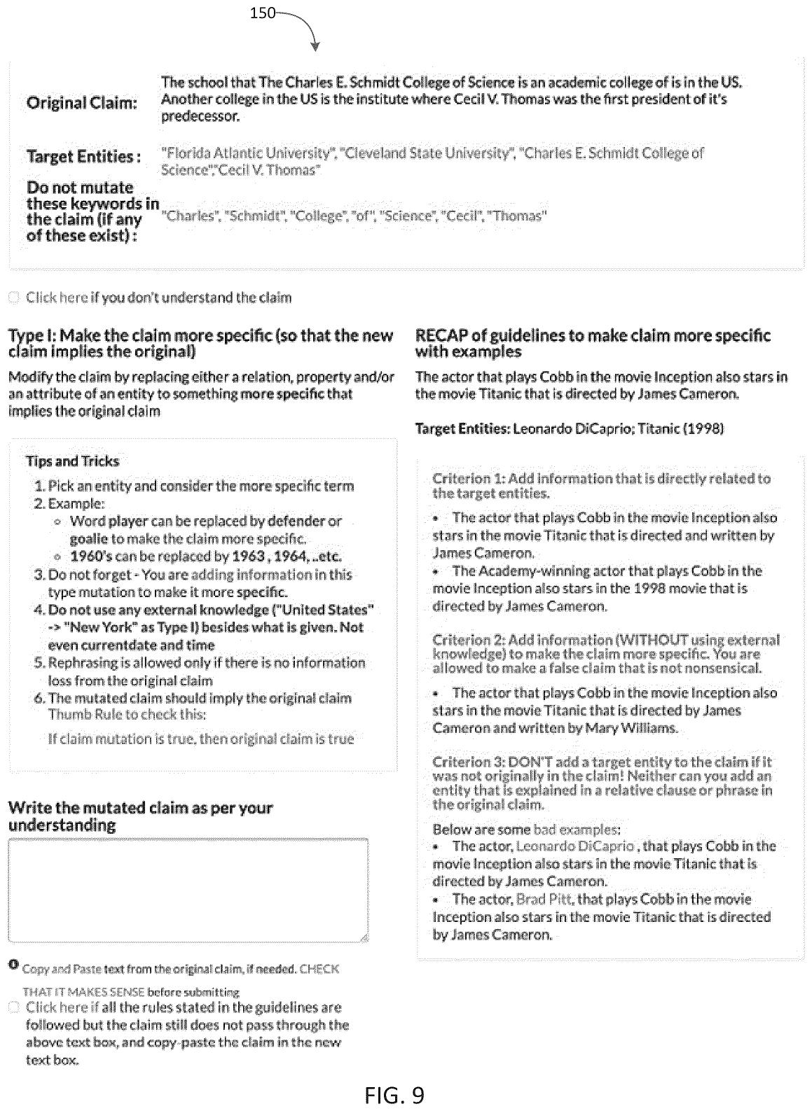

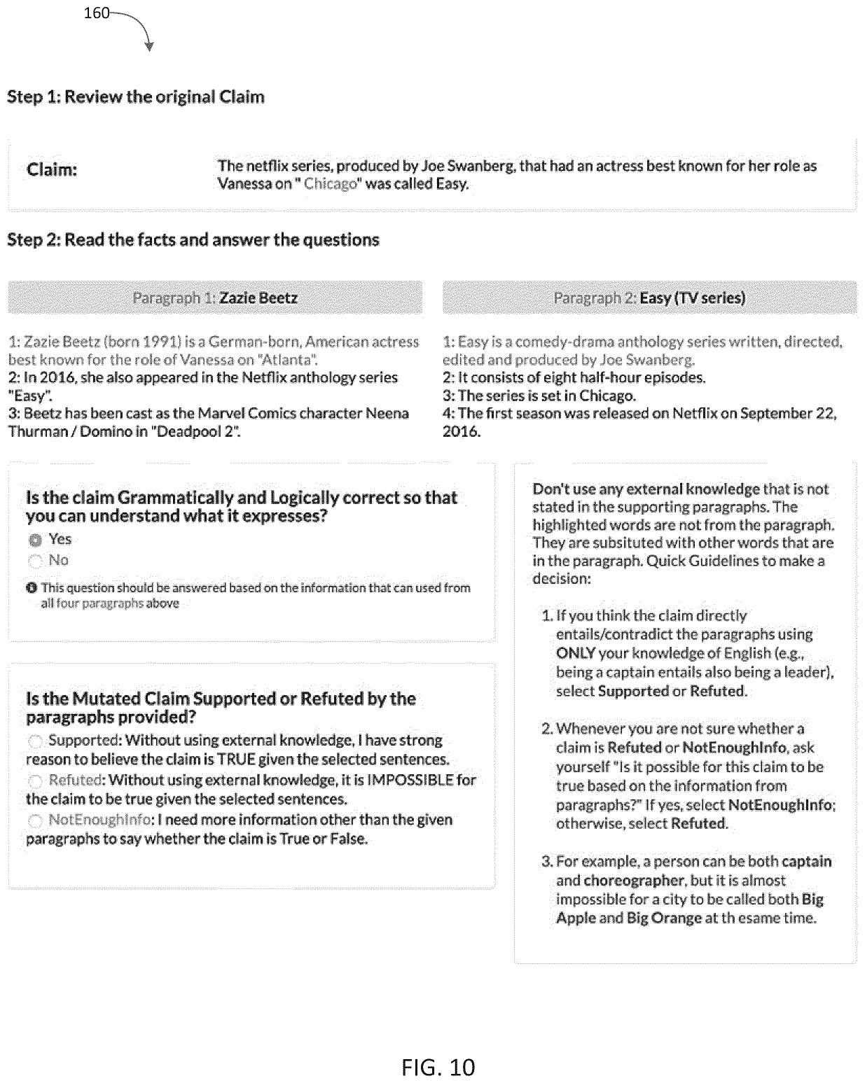

In some embodiments, the system 10 can generate various user interfaces to assist with collecting data that is processed by the system. FIG. 8 illustrates a screenshot of a user interface 140 generated by the system 10 of the present disclosure that allows a user to extend a 3-hop claim into a 4-hop claim, for subsequent machine learning by the system. FIG. 9 illustrates a screenshot of a user interface 150 generated by the system 10 of the present disclosure to create more specific claims, for subsequent machine learning by the system. FIG. 10 illustrates a screenshot of a user interface 160 generated by the system 10 of the present disclosure for labeling claims, which labels are subsequently processed by machine learning.

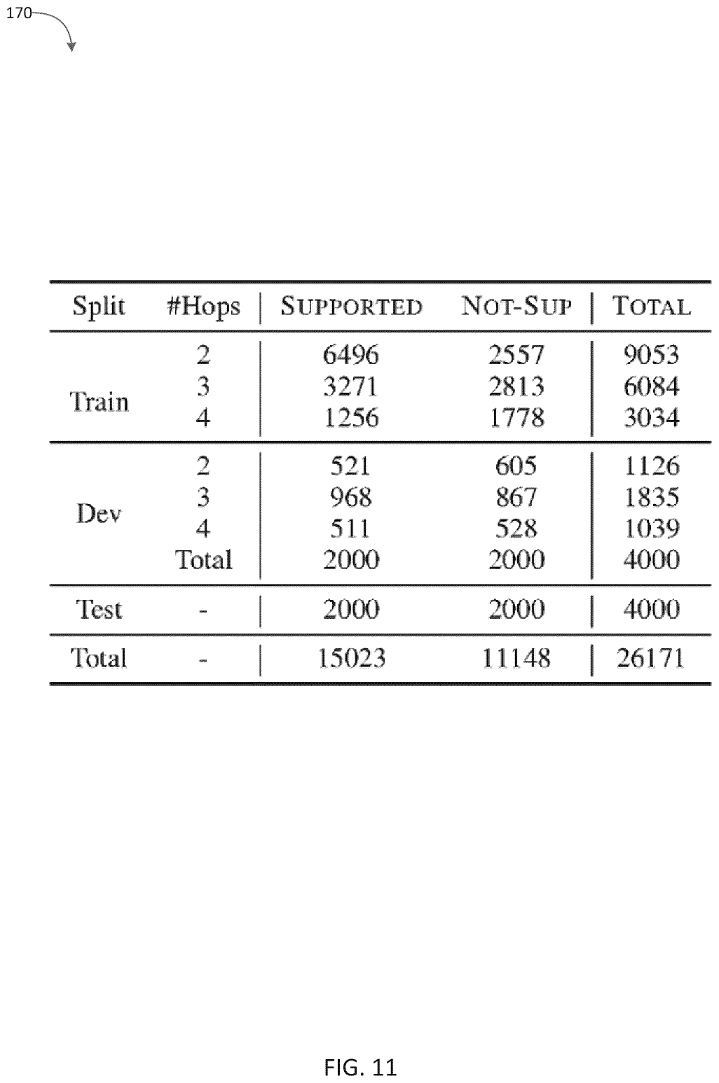

In some embodiments, the system 10 can perform a dataset analysis on the HoVer dataset. For example, the system 10 can partition the annotated claims and evidence of the HoVer dataset into training, development (dev), and test sets for the creation of a machine learning model. A training set is used to train a machine learning model for learning to fit parameters (e.g., weights of connections between neurons in a neural network, or the like) of the machine learning model. A development set provides an unbiased evaluation of the model fit on the training data set while tuning the model's hyperparameter (e.g., choosing the number of hidden unites in a neural network, or the like). A test set provides an unbiased evaluation of a final model fit on the training data set. The detailed statistics are shown in FIG. 11 (which illustrates a table 170 showing the sizes of the Train-Dev-Test split for SUPPORTED and NOT-SUPPORTED classes and different number of hops for the creation of machine learning models of the system 10 of the present disclosure). Because of the job complexity, judgment time, and the difficulty of quality control increase drastically along with the number of hops of a claim, in some embodiments, the HoVer dataset can use 12k examples from a QA database (e.g., HOTPOTQA database). The 2-hop, 3-hop and 4-hop claims can have a mean length of 19.0, 24.2, and 31.6 tokens respectively as compared to a mean length of 9.4 tokens of the existing technologies.

As another example, as described above, the system 10 includes diverse many-hop reasoning graphs. As questions from HOTPOTQA database need two supporting documents, the 2-hop claims created by the system 10 using the HOTPOTQA question-answer pairs inherit the same 2-node reasoning graph as shown in the first row in FIG. 4. However, as the system 10 extends the original 2-hop claims to more hops using approaches described above, the system 10 achieves many hop claims with diverse reasoning graphs. Every node in a reasoning graph is a unique document that contains evidence, and an edge that connects two nodes represents a hyperlink from the original document or a comparison between two titles. As shown in FIG. 4, the system 10 can have three unique 4-hop reasoning graphs that are derived from the 3-hop reasoning graph by appending the 4th node to one of the existing nodes in the graph.

In some embodiments, the system 10 can perform qualitative analysis. The process of removing a bridge entity and replacing it with a relative clause or phrase adds a lot of information to a single hypothesis. Therefore, some of the ¾-hop claims are of relatively longer length and have complex syntactic and reasoning structure. In some embodiments, overly complicated claims can be discarded if they are reported as ungrammatical or incomprehensible by annotators. The resulting examples form a challenging task of evidence retrieval and multi-hop reasoning. It should be understood that the system 10 can perform the aforementioned tasks (e.g., user interface generation, dataset analysis, and qualitative analysis) via the data collection engine 18a.

Referring back to FIG. 2, in step 56, the system 10 selects, based at least in part on the one or more machine learning models, a set of sentences from the document. The set of sentences have second relatedness scores higher than a second threshold indicating that the one or more machine learning models determine that the set of sentences are most likely to be relevant to the claim. For example, the system 10 can fine-tune another machine learning model (e.g., a BERT-base model) that encodes the claim c and all sentences from the document p∈Pₙ, and predicts the sentence relatedness scores using the first token of every sentence. For example, the system 10 can rank the sentences having relatedness scores higher that a second threshold of Ks, and selects a set Sₙ (e.g., multiple sentences of top-ranking kₛ sentences). It should be understood that the system 10 can perform the aforementioned task via the sentence selection engine 18c.

In step 58, the system 10 determines, based at least in part on the one or more machine learning models, whether the claim includes one or more facts from the set of sentences. The system 10 can use a natural language inference model (e.g., BERT-base model, a binary classification model) to classify the claim based on the set of the sentences. For example, the system 10 uses the BERT-base model to recognize textual entailment between the claim c and the retrieved evidence Sₙ. The system 10 feeds the claim and retrieved evidence, separated by a [SEP] token, as the input to the BERT-base model and performs a binary classification based on the output representation of the [CLS] token at the first position. It should be understood that the system 10 can perform the aforementioned task via the claim verification engine 18d.

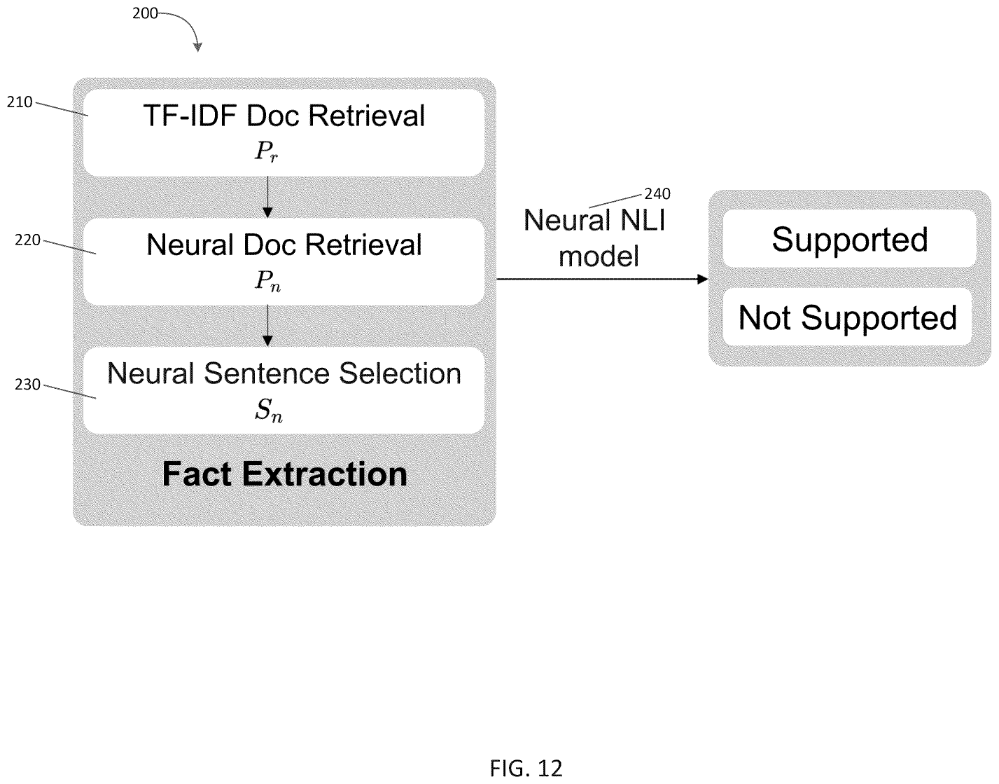

In some embodiments, the system 10 can have 4-stage architecture as shown in FIG. 12 (which illustrates a baseline system 200 with a 4-stage architecture of the present disclosure). The baseline system 200 (e.g., one of embodiments of the system 10) performs fact extraction by performing TF-IDF document retrieval 210, neural document retrieval 220, and neural sentence selection 230 sequentially. The baseline system 200 inputs the set of sentences and the claim from the fact extraction into a neural natural language inference (NLI) model 240 to determine whether the claim is supported by the set of sentences or is not supported.

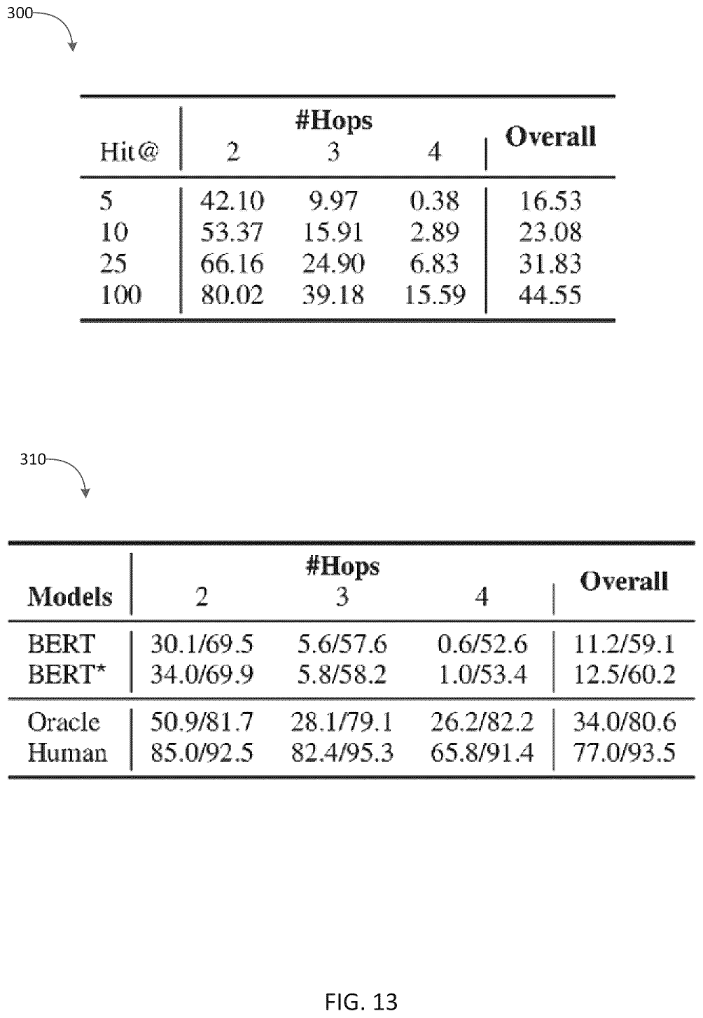

In step 60, the system 10 determines an accuracy of the one or more machine learning models by comparing the determinations of the one or more machine learning models with ground truth data provided by the dataset. In some embodiments, the system 10 can evaluate an accuracy of the claim verification task to predict a claim as SUPPORTED or NOT-SUPPORTED. The document and sentence retrieval are evaluated by the exact-match and F1 scores between the predicted document/sentence level evidence and the ground-truth evidence for the claim. It should be understood that the system 10 can perform the aforementioned task via the evaluation engine 18e. Results for document retrieval, sentence selection, claim verification, and full pipeline are described below with respect to FIGS. 13-15.

In some embodiments, the system 10 uses the HoVer dataset to train the one or more machine learning models (e.g., pre-trained BERT models and pre-trained NLI models) by performing the steps 52-60 using the training set, the development set and the test set of the HoVer dataset. For example, the system 10 uses the training set to train one or more machine learning models of the system 10 for learning to fit parameters of the one or more machine learning models. The system 10 uses the development set to tune hyperparameter of the one or more machine learning models. They system 10 further uses a test set to assess the performance of the final models. It should be understood that the system 10 can perform the aforementioned task via the training engine 18f.

For example, an experimental setup of the system 10 can use the pre-trained BERT-base uncased model (with 110M parameters) for the tasks of neural document retrieval, sentence selection, and claim verification. The fine-tuning is done with a batch size of 16 and the default learning rate of 5e-5 without warmup. The system 10 sets kᵣ=20, kₚ=5, κₚ=0.5, and κₛ=0.3 based on the memory limit and the development (dev) set performance. The system 10 selects the best dev-set verification accuracy and reports scores on the hidden test set. The entire pipeline is visualized in FIG. 12 as described above. For document retrieval and sentence selection tasks, the system 10 fine-tunes the BERT on 4 Nvidia V100 GPUs for 3 epochs. The training of both tasks takes around 1 hour. For claim verification task, the system 10 fine-tunes the BERT on a single Nvidia V100 for 3 epochs. The training finishes in 30 minutes. Experiments and results are described in FIGS. 13-15.

FIG. 13 illustrates a table 300 showing performance of TF-IDF document retrieval and a table 310 showing EM/F1 scores of neural based document retrieval models evaluated on supported claims in a development set of the system 10 of the present disclosure. The results in the table 300 show that the task becomes significantly harder for the bi-gram TF-IDF when the number of supporting documents increases. This decline in single-hop word-matching retrieval rate suggests that the HoVer dataset having extended reasoning hops is effective in terms of promoting multi-hop document retrieval and minimizing word-matching reasoning shortcuts. The system 10 then uses a BERT-base model (the 1st row in the table 310) to re-rank the top-20 documents returned by the TF-IDF. The “BERT*” (the 2nd row in the table 310) is trained with an oracle training set containing all golden documents. Overall, the performances of the neural models are limited by the low recall of the 20 input documents and the F1 scores degrade as the number of hops increase. The oracle model (the 3rd row in the table 310) is the same as “BERT*” but evaluated on the oracle data. It indicates an upper bound of the BERT retrieval model given a perfect rule-based retrieval method. These findings again demonstrate the high quality of the many-hop claims of the HoVer dataset of the system 10, for which the reasoning shortcuts are significantly reduced.

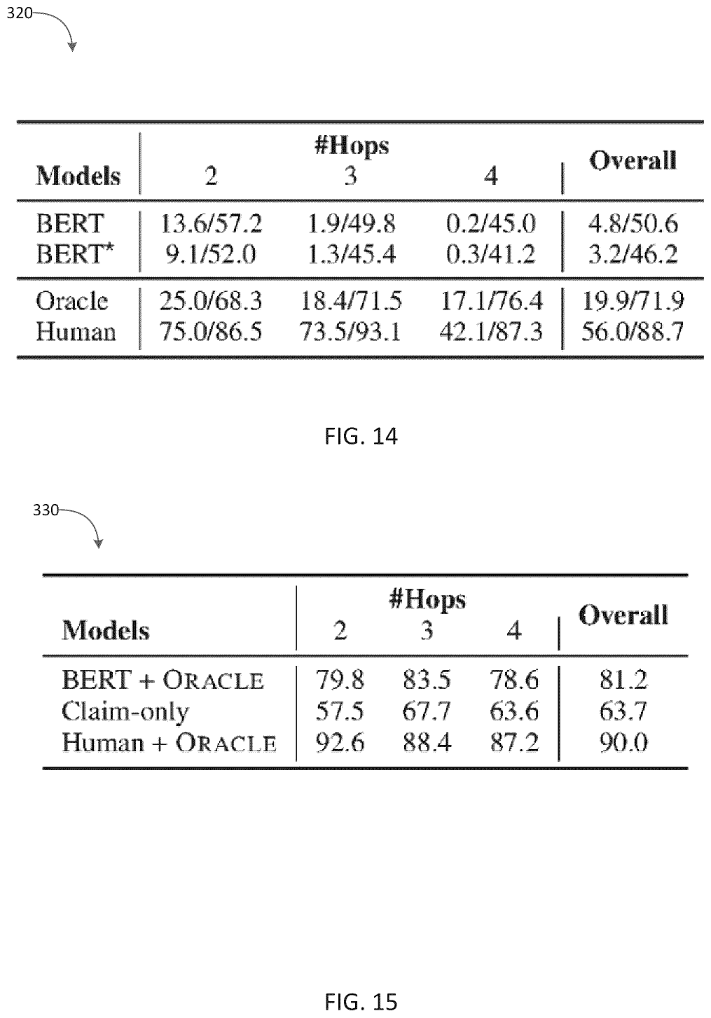

FIG. 14 illustrates a table 320 showing EM/F1 scores of sentence retrieval models evaluated on supported claims in a development set of the system 10 of the present disclosure. The system 10 evaluates neural-based sentence selection models by re-ranking the sentences within the top 5 documents returned by the neural document retrieval method. For “BERT*” (the 2nd row in the table 320), all golden documents are contained within the 5 input documents during the training. The system 10 then measures the oracle result by evaluating “BERT*” on the dev set with all golden documents presented. This suggests an upper bound of the sentence retrieval model given a perfect document retrieval method. The same trend holds as the F1 scores decrease significantly as the number of hops increases.

FIG. 15 illustrates a table 330 showing claim verification accuracy of natural language inference (NLI) models evaluated on supported claims in a development set of the system 10 of the present disclosure. In an oracle (the 1st row in the table 330) setting where the complete set of evidence is provided, the NLI model (e.g., BERT model having the oracle setting) achieves 81.2% accuracy in verifying the claims. A sanity check is conducted in a claim-only environment (the 2nd row in the table 330) where the NLI model can only exploit the bias in the claims without any evidence, in which the NLI model achieves 63.7% accuracy. Although the NLI model can exploit limited biases within the claims to achieve higher-than-random accuracy without any evidence, it is still 17.5% worse than the NLI model given the complete evidence. This suggests the NLI model can benefit from an accurate evidence retrieval model significantly.

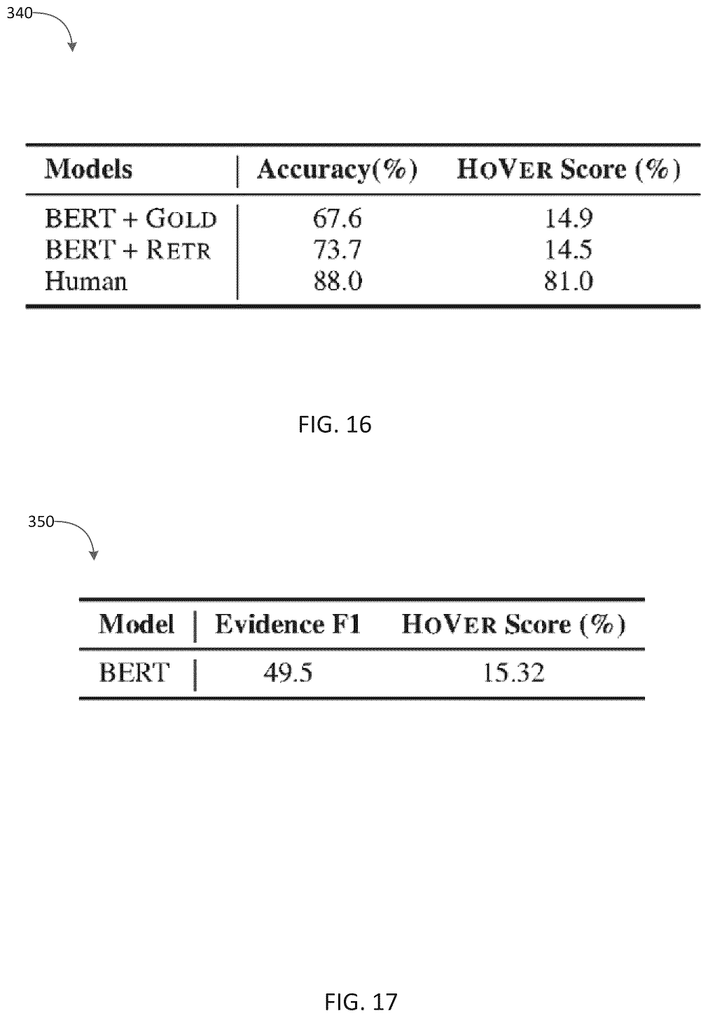

FIG. 16 illustrates a table 340 showing claim verification accuracy and HoVer scores of an entire pipeline evaluated on supported claims in a development set of the system 10 of the present disclosure. A full pipeline (“BERT+Retr” in the table 340) uses sentence-level evidence retrieved by the best document/sentence retrieval models as the input to the NLI models, while the “BERT+Gold” is the oracle in the table 330 but evaluated with retrieved evidence instead. The system 10 further proposes the HoVer score, which is the percentage of the examples where the model retrieves at least one supporting fact from every supporting document and predicts a correct label. The performance of the best model (BERT+Gold in the table 340) on the test set in a table 350 in FIG. 17 (which illustrates a table 350 showing evidence F1 score and HoVer score of the best model of FIG. 16, evaluated on the test set of the system of the present disclosure). Overall, the best pipeline can only retrieve the complete set of evidence and predict the correct label for 14.9% of examples on the dev set and 15.32% of examples on the test set, suggesting that the Ho Ver dataset is indeed more challenging than the previous work of this kind, which indicating that HoVer dataset encourages the development of existing state-of-the-art models capable of performing complex many-hop reasoning in the tasks of information retrieval and verification.

The HoVer dataset provides further technical benefits. For example, claims of the HoVer dataset vary in size from one sentence to one paragraph and the pieces of evidence are derived from information from one or more documents, while other datasets include single sentence claims that are verified against the pieces of evidence retrieved from two or fewer documents. In the HoVer dataset, claims need verification from multiple documents. Prior to verification, the relevant documents and the context inside these documents are retrieved accurately, while other datasets challenge participants to fact verify claims using evidence from Wikipedia and to attack other participant's system with adversarial models. Other datasets are mostly presented in the question answering format, while the HoVer dataset is instead created for the task of claim verification. Further, the HoVer dataset is significantly larger in the size while also expanding the richness in language and reasoning paradigms.

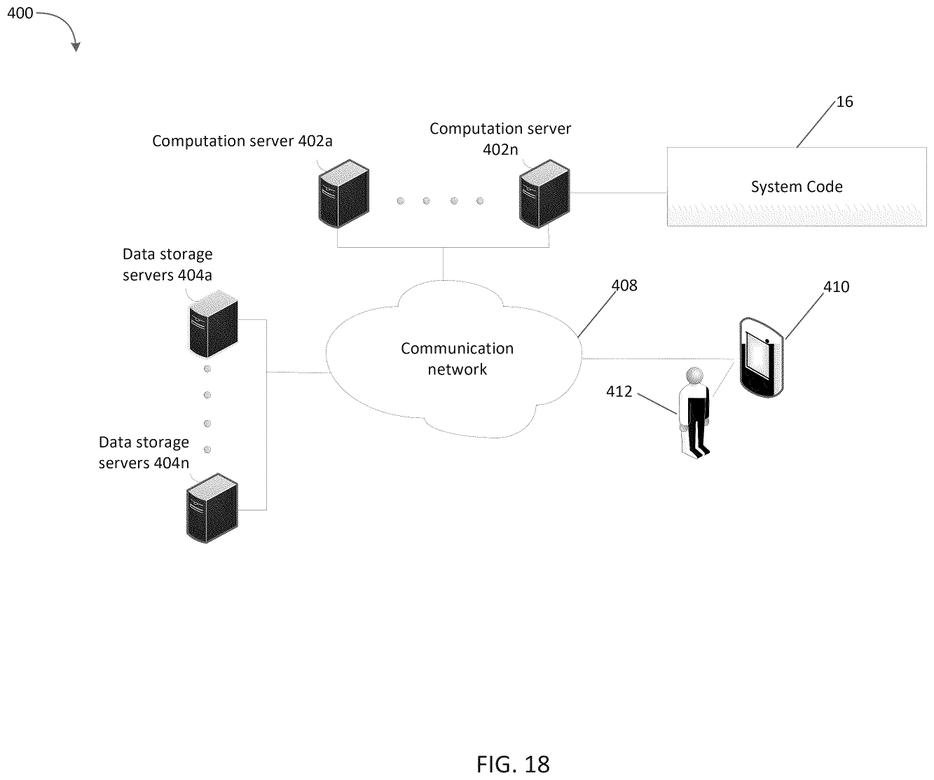

FIG. 18 is a diagram illustrating computer hardware and network components on which the system 400 can be implemented. The system 400 can include a plurality of computation servers 402a-402n having at least one processor (e.g., one or more graphics processing units (GPUs), microprocessors, central processing units (CPUs), etc.) and memory for executing the computer instructions and methods described above (which can be embodied as system code 16). The system 400 can also include a plurality of data storage servers 404a-404n for storing the HoVer dataset. A user device 410 can include, but it not limited to, a laptop, a smart telephone, and a tablet to display user interfaces for data collection and to receive user inputs to a user 412, and/or to provide feedback for fine-tuning the models. The computation servers 402a-402n, the data storage servers 404a-404n, and the user device 410 can communicate over a communication network 408. Of course, the system 400 need not be implemented on multiple devices, and indeed, the system 400 can be implemented on a single (e.g., a personal computer, server, mobile computer, smart phone, etc.) without departing from the spirit or scope of the present disclosure.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following Claims.

1. A computer-implemented method for training a machine learning model for fact extraction and claim verification, comprising:
creating a first group of claims supported by facts from more than two supporting documents from a plurality of supporting documents;
creating a second group of claims not supported by the plurality of supporting documents;
dividing the first group of claims and the second group of claims into a plurality of training datasets;
training the machine learning model in a first stage of a plurality of stages using a first training dataset of the plurality of training datasets; and
training the machine learning model in a second stage of the plurality of stages using a second training dataset of the plurality of training datasets.

2. The computer-implemented method of claim 1, wherein the step of creating the first group of claims comprises:
creating a plurality of valid (n-1)-hop claims, each (n-1)-hop claim supported by one or more facts from (n-1) supporting documents of the plurality of supporting documents, wherein n is an integer number equal to or greater than 2;
extending the plurality of valid (n-1)-hop claims to a plurality of n-hop claims by substituting one or more entities of each valid (n-1)-hop claim with information from an additional supporting document of the plurality of supporting documents, the information describing the one or more entities; and
creating the first group of claims based at least in part on the plurality of n-hop claims.

3. The computer-implemented method of claim 1, wherein the second group of claims comprise claims having information that is not in the first group of claims, or claims having less information than the first group of claims.

4. The computer-implemented method of claim 1, further comprising automatically substituting one or more words of at least one claim of the first group of claims with one or more new words predicted by an additional machine learning model to form at least one claim of the second group of claims.

5. The computer-implemented method of claim 1, further comprising automatically substituting one or more entities of at least one claim of the first group of claims with one or more new entities that are not titles of any supporting documents of the at least one claim to form at least one claim of the second group of claims.

6. The computer-implemented method of claim 1, further comprising creating at least one claim of the second group of claims by removing or adding one or more negation words, or substituting a phrase with its antonyms in at least one claim of the first group of claims.
